(19) United States
(12) Patent Application Publication
(10) Pub. No.: US 2013/0342943 A1
(43) Pub. Date: Dec. 26, 2013

(54) INPUT PROTECTION CIRCUIT

(71) Applicant: PANASONIC CORPORATION, Osaka (JP)

(72) Inventors: Hisanori YUUKI, Osaka (JP); Yoshihide KOMATSU, Osaka (JP); Toru IWATA, Osaka (JP); Yutaka NAKAMURA, Kyoto (JP)

(73) Assignee: PANASONIC CORPORATION, Osaka (JP)

(21) Appl. No.: 13/975,041

(22) Filed: Aug. 23, 2013

Related U.S. Application Data
(63) Continuation of application No. PCT/JP2011/004197, filed on Jul. 26, 2011.

(30) Foreign Application Priority Data
Feb. 25, 2011 (JP) 2011-040329

(51) Int. Cl. H02H 3/20

(52) U.S. Cl. CPC H02H 3/20
USPC 361/58; 361/91.5

(57) ABSTRACT

In an input protection circuit, one end of a resistive element of a protection circuit is connected to an intermediate impedance point of a terminating device, which is connected between a pair of external terminals of a low amplitude differential interface circuit. The other end of the resistive element is connected to an anode terminal of a diode element. A cathode terminal of the diode element is connected to a reference potential terminal. As a result, even when one of external terminals of a low-breakdown voltage circuit is erroneously in contact with a signal terminal (i.e., a bus terminal which is always pulled up via a high resistance resistor) of the socket to be pulled up to a high voltage, the elements forming the circuit are greatly protected from deterioration and damages at low costs, while maintaining the quality of transmission signals.

### CROSS-REFERENCE TO RELATED APPLICATIONS

This is a continuation of International Application No. PCT/JP2011/004197 filed on Jul. 26, 2011, which claims priority to Japanese Patent Application No. 2011-040329 filed on Feb. 25, 2011. The entire disclosures of these applications are incorporated by reference herein.

### BACKGROUND

The present disclosure relates to input protection circuits for low-amplitude interface circuits, and more particularly to protection of low-breakdown interface circuits in mobile memory cards inserted into host devices including combination sockets from pull-up to unintended high voltages.

In recent years, mobile memory cards have been used for movie capturing devices etc., an increase in memory capacity progresses with an increase in the scale of data amount. Accordingly, an increase in the rate of data transmission between a mobile memory card and a host device is demanded. For example, a data transmission rate up to 6 Giga bit per second (Gbps) is accepted in the specification of a universal flash storage (UFS), which is being standardized in JEDEC. On the other hand, in the specification of a UHS-II, which is being standardized in SD Association, multichannel data transmission up to 3 Gbps per channel is possible.

In Gbps-class data transmission, low-amplitude interfaces are generally used. In particular, low amplitude differential interfaces are widely used for purposes strictly requiring noise tolerance and limitation on radiated electromagnetic waves. For example, low voltage differential signaling (LVDS) is a representative. One of the features is that a constant current of about 3.5 mA flows to the terminating resistor 100Ω between differential signal wirings at a receiver, thereby establishing impedance matching with a signal transmission line and ensuring the amplitude at the receiver. This improves the quality of a reception signal, which is an advantage.

Reduction in the power consumption is one of issues in high-speed transmission. At present, the signal amplitude is set around 300 mV under a widely used low-amplitude differential interface standard. The specification of a common voltage of differential signals is determined around a reference potential, thereby lowering the power supply voltage of an interface circuit to around 1 V, and reducing the power consumption, which is also an advantage of low-amplitude differential interface.

On the other hand, there are various mobile memory card standards such as an SD card, an MMC, a memory stick, CompactFlash (registered trademark). With a few exceptions, different standards rarely share a mechanical specification and an electrical specification.

Under these circumstances, personal computer providers mount card readers having a mechanism called a combination socket, which accepts mobile memory cards of a plurality of different standards using a single opening, thereby improving the commercial value. It is thus inevitable that a mobile memory card under a new standard will be inserted into an existing combination socket. In designing the standard in the future, there is a need to determine the layout specification of an electrode terminal of the mobile memory card to avoid the electrode terminal itself from coming into contact with an electrode terminal for the mobile memory card located at a socket side under a different standard.

In a mobile memory card, there is a need to design not only a transmission/reception circuit, but also the physical position of an electrode terminal for ensuring excellent characteristics to achieve high-speed transmission using a low-amplitude interface. As another aspect, where the data transmission rate of mobile memory cards employing an existing standard is to be increased, providing upper compatibility is an effective commercial strategy so that the memory card is used by inserting a socket under the existing standard to maintain the availability for users. In this case, the form factor of a newly designed mobile memory card needs to maintain the conventional standard, and needs to avoid contact with an electrode terminal under other standards.

However, if the layout of electrode terminals is combined in a combination socket accepting a plurality of types of existing mobile memory card standards, the positions for providing an additional electrode terminal are limited. The positions providing excellent electrical characteristics are further limited. Thus, it cannot be avoided that a position of an electrode terminal for a mobile memory card closes in an electrode terminal of another mobile memory card standard.

An electrode terminal of a socket is in the form of spring to reduce the contact resistance when in contact with the electrode terminal of the mobile memory card. When the electrode terminals of the mobile memory card under different standards are located close to each other, the pressure of the electrode terminal of the socket slides the electrode terminal, which is not to be in contact, into a dent of the opening of the electrode terminal of the mobile memory card and then electrically connected. In this case, the following problems occur. Usual signal communications are not ensured. When power supply voltages of interfaces are different, short-circuit current or excess of the voltage applied to a lower voltage element over the breakdown voltage of the element causes damage.

For example, in an existing SD card or MMC, single end interfaces of 3.3 V are used. As reduction in the voltage of interfaces progresses to reduce the power consumption, a combination socket also includes terminals for a mobile memory card mounting an interface using a power supply voltage of 1.8 V or 1.2 V, thereby exposing damages caused by the excess over the breakdown voltage. This problem directly leads to the reliability and safety of the product, and is thus not negligible.

A clamping circuit with a diode element is added to reduce the voltage to a desired voltage when a high voltage is applied to a terminal. FIGS. 14A and 14B are example diode clamping circuits. FIG. 14A shows an example of a clamping circuit utilizing forward direction of a junction diode. A clamping circuit 20 includes a diode 21. When a forward direction voltage is higher than or equal to a threshold voltage V_{F}, the diode 21 fixes a termination voltage, which is to shift to the threshold voltage V_{F} or higher, utilizing the electrical characteristics of reducing the resistance between the terminals. FIG. 15 illustrates the electrical characteristics of the diode.

FIG. 14B illustrates that a clamping circuit 20 includes a Zener diode. In the figure, the clamping circuit 20 is formed by connecting inverted direction of the Zener diode 22. The Zener diode 22 fixes a termination voltage, which is to shift to the Zener voltage |V_{Z}| or higher, utilizing the electrical characteristics that the resistance decreases between the terminals of the diode when the termination voltage is lower than or equal to a Zener voltage V_{Z}. In voltage clamping circuits, the method using the Zener diode are used relatively often.

The above-described methods are effective as a measure for limiting input voltages when in contact with an external power supply terminal or a driver circuit driven at low impedance.

However, the following problems occur in using these methods in Gbps-class high-speed transmission systems.

Specifically, variation in the threshold voltages of diodes is a problem in a diode clamping circuit. If the threshold of a diode is lower than the upper limit voltage of a low-amplitude interface signal, the clamping diode is turned on in transmitting the signal, thereby reducing the resistance. At this time, the signal waveform is clamped, and the low resistance of the diode is dominant in the termination impedance, thereby causing a reflected wave having an inverted signal voltage waveform. The reflected wave transmits a transmission path to cause electromagnetic interference (EMI). Even if the threshold voltage of the diode does not exceed the breakdown voltage of the internal device, as long as it exceeds the power supply voltage of the low-amplitude interface circuit, the potential of the signal terminal exceeds the power supply voltage when a high voltage is applied from the outside. At this time, when the low-amplitude interface circuit includes a CMOS transistor, a p-channel MOS transistor having a gate terminal connected to the external terminal meets characteristics degradation conditions called positive bias temperature instability (PBTI). Thus, another problem of accelerating the degradation in the characteristics of the p-channel MOS transistor under the PBTI conditions occurs. That is, the threshold voltage of the clamping diode needs to fall within the range from the upper limit voltage of the low-amplitude interface signal to the lower-limit voltage of the power supply.

Such problems caused by the variations are obvious when the protection circuit is formed on a semiconductor integrated circuit including CMOS transistors. Use of separate units of diode part to reduce the variations increases the cost of the parts and the mounting area of the parts on the PCB, thereby increasing the manufacturing costs.

As shown in, for example, Japanese Patent Publication No. 2000-22508, forming a source voltage follower circuit by a MOS transistor and a differential amplifier, and deciding a clamping voltage using a reference voltage are an effective method of accurately controlling a clamping voltage.

### SUMMARY

However, the technique shown in Japanese Patent Publication No. 2000-22508 has a problem of input capacitance.

Specifically, when the diode characteristics of a Zener diode and a MOS transistor, it is particularly problematic that depletion layer capacitance is added as terminal capacitance. A terminal electrode of an interface circuit is exposed to the outside and the interface circuit is subjected to electrostatic discharge etc. Thus, protection circuits include parts for protection circuits such as diode elements on an integrated circuit and a varistor, which are added extra. The total capacitance of the protection circuit and the interface circuit component themselves exists as the terminal capacitance specific to the system. The terminal capacitance functions to reduce the input/output impedance of a high frequency signal component. When the impedance of the terminal capacitance starts to antagonize the impedance of the terminating device, the absolute value of the combined impedance with the impedance of the terminating device decreases to shift the phase of the combined complex impedance from the original impedance of the terminating device. The phase shift of the complex impedance of the terminating device causes impedance mismatch, thereby causing an influence on the signal quality. Furthermore, when the frequency increases and the impedance of the terminal capacitance is lower than the impedance of the terminating device, the impedance of the terminal capacitance is dominant and the combined impedance of the terminating device and terminal capacitance comes out of an anticipated terminating impedance range.

This is a fatal problem of every interface circuit. Addition of a clamping circuit causes an increase in the terminal capacitance, thereby reducing the cutoff frequency of the combined impedance with the impedance of the terminating device and not allowing impedance matching at lower frequency than without clamping circuit. Accordingly, an influence on the harmonic component forming the edges of a signal waveform increases. Specifically, the influence appears as distortion or dullness of the input signal waveform. This phenomenon causes reduction in data windows by inter-symbol interfere (ISI), thereby increasing the error rate in data transmission.

The present disclosure addresses the problem. A diode element is included in an input protection circuit whose terminating device is connected to an external terminal of an interface circuit. Where an employed configuration clamps a high voltage caused by terminal contact and erroneously applied to the external terminal, it is an objective of the present disclosure to greatly clamp the high voltage and not to influence the impedance characteristics of the terminating device, even if the diode element is added to terminal.

In order to achieve the objective, in an input protection circuit according to the present disclosure, a protection circuit including a resistive element and a diode element, which are connected in series, is provided in parallel to a terminal device of an interface circuit. Assume that external terminal comes into contact with a bus signal always pulled up via a high resistive resistor. Specifically, for example, assume that an external electrode of an interface circuit having a breakdown voltage of 1.2V comes into contact with an electrode terminal, which is pulled up to a power supply voltage of 3.3 V with resistance ranging from 10 kΩ to 100 kΩ of a combination socket. The protection circuit functions as a pull down circuit using the resistive element of the protection circuit to address high voltage application, in which a voltage of 3.3 V is continuously applied via a pull-up resistor. The protection circuit functions as high impedance to cope with an input signal in normal low amplitude signal transmission not to influence the impedance characteristics of the terminating device.

Specifically, an input protection circuit according to a first aspect of the present disclosure is equipped with an external terminal, and configured to limit a voltage applied to a low-amplitude interface circuit connected to the external terminal when the external terminal is connected via a resistor to a voltage supply having a voltage exceeding an acceptable applied voltage. The input protection circuit includes a terminating device connected to the external terminal; and a protection circuit connected in parallel to the terminating device. The protection circuit includes a resistive element having an end connected to the external terminal, and a diode element having an anode terminal connected to another end of the resistive element, and a cathode terminal connected to a reference potential terminal.

According to a second aspect of the present disclosure, in the input protection circuit of the first aspect, termination impedance obtained within a frequency range required by the terminating device for matching is represented by a real number. Resistance of the resistive element of the protection circuit is determined such that an absolute value of parallel combined impedance of impedance of the resistive element and the termination impedance falls within a predetermined fluctuation range from an absolute value of the termination impedance.

According to a third aspect of the present disclosure, in the input protection circuit of the second aspect, the predetermined fluctuation range is within 5% of the absolute value of the termination impedance.

According to a fourth aspect of the present disclosure, in the input protection circuit of the first aspect, resistance of the resistive element of the protection circuit is determined such that an absolute value of parallel combined impedance of the resistive element and termination impedance, which is obtained within a frequency range required by the terminating device for matching, falls within a fluctuation range of 3% from an absolute value of the termination impedance, and such that a phase difference between a phase of the parallel combined complex impedance and a phase of the termination complex impedance falls within 2 degrees.

According to a fifth aspect of the present disclosure, in the input protection circuit of the first aspect, the diode element is a MOS transistor element on a semiconductor integrated circuit.

According to a sixth aspect of the present disclosure, in the input protection circuit of the first aspect, the low-amplitude interface circuit is a differential interface circuit. Both ends of the terminating device are connected to a pair of differential signal terminals of the differential interface circuit. A series-connected circuit of the resistive element and the diode element is connected to one or both of the pair of differential signal terminals.

An input protection circuit according to a seventh aspect of the present disclosure is equipped with an external terminal, and configured to limit a voltage applied to a low-amplitude interface circuit connected to the external terminal when the external terminal is connected via a resistor to a voltage supply having a voltage exceeding an acceptable applied voltage. The input protection circuit includes a terminating device connected to the external terminal; and a protection circuit connected in parallel to the terminating device. The protection circuit includes a resistive element having an end connected to the external terminal, and an n-type MOS transistor having a drain terminal connected to another end of the resistive element, and a source terminal connected to a reference potential terminal, and a differential amplifier having an output terminal connected to a gate terminal of the n-type MOS transistor, a non-inverting input terminal of the differential amplifier being connected to the drain terminal of the n-type MOS transistor, and an inverting input terminal of the differential amplifier receiving a reference voltage generated by a reference voltage generator.

According to an eighth aspect of the present disclosure, in the input protection circuit of the seventh aspect, termination impedance obtained within a frequency range required by the terminating device for matching is represented by a real number. Resistance of the resistive element of the protection circuit is determined such that an absolute value of parallel combined impedance of the resistive element and the termination impedance falls within a predetermined fluctuation range from an absolute value of the termination impedance.

According to a ninth aspect of the present disclosure, in the input protection circuit of the eighth aspect, the predetermined fluctuation range is within 5% of the absolute value of the termination impedance.

According to a tenth aspect of the present disclosure, in the input protection circuit of the seventh aspect, resistance of the resistive element of the protection circuit is determined such that an absolute value of parallel combined impedance of the resistive element and termination impedance, which is obtained within a frequency range required by the terminating device for matching, falls within a fluctuation range of 3% from an absolute value of the termination impedance, and such that a phase difference between a phase of the parallel combined complex impedance and a phase of the termination complex impedance falls within 2 degrees.

An input protection circuit according to an eleventh aspect of the present disclosure is equipped with a pair of external terminals, and configured to limit a voltage applied to a low-amplitude interface circuit connected to one or both of the pair of external terminals when the one or both of the pair of external terminals is/are connected via a resistor to a voltage supply having a voltage exceeding an acceptable applied voltage. The input protection circuit includes a terminating device connected between the pair of external terminals; and a protection circuit connected in parallel to the terminating device. The protection circuit includes a resistive element having an end connected to an intermediate impedance point of the terminating device, and a diode element having an anode terminal connected to another end of the resistive element, and a cathode terminal connected to a ground terminal.

According to a twelfth aspect of the present disclosure, the input protection circuit of the eleventh aspect, further includes at the intermediate impedance point of the terminating device, a switch switchable between electrical connection and disconnection between the pair of external terminals via the terminating device. A series-connected circuit of the resistive element and the diode element is connected to each terminal of the switch.

According to a thirteenth aspect of the present disclosure, in the input protection circuit of the eleventh aspect, the diode element is a MOS transistor element on a semiconductor integrated circuit.

In the present disclosure, the protection circuit including the resistive element and the diode element, which are connected in series, and provided in parallel to the terminating device is used as a measure against pull up of an external voltage exceeding the breakdown voltage of the internal device. With this configuration, when a high voltage is applied from the outside, the anode of the diode element of the protection circuit is charged via the resistive element of the protection circuit. When the voltage exceeds the threshold of the diode element, the diode element is turned on and powered. As shown in FIG. 15, when the voltage exceeds the threshold V_{F}, the current characteristics of the diode element shows low impedance characteristics, and thus, the voltage at the anode of the diode element remains around the threshold, the difference between the external voltage and the threshold voltage is covered by a pull-up resistor, which is connected to the external voltage side, and a resistive element of the protection circuit. At this time, the voltage for stabilizing the external terminal is determined by the division ratio of the external pull-up resistor to the resistive element of the protection circuit. Therefore, how to determine the resistance of the resistive element of the protection circuit is important in the present disclosure.

In transmission of a low amplitude signal, the protection circuit operates at an intermediate value between the power supply potential at the interface side and the reference potential. When the maximum value of the signal potential does not exceed the threshold of the diode element, the diode element is off and no current flows. The impedance at the protection circuit is high, thereby slightly influencing the termination parameter. Although a slight direct current is generated when the maximum value of the signal potential exceeds the threshold voltage of the diode element, the termination parameter is slightly influenced, thereby reducing an influence on a signal component, which is an alternating current.

Where the interface circuit is a differential interface circuit, in which a terminating resistor is connected between a non-inverted signal and an inverted signal, similar advantages are provided by providing a protection element including a resistive element and a diode element connected in series is provided in one or both of differential signal terminals.

Furthermore, in a differential interface circuit, providing a protection circuit in a node corresponding to an intermediate point of termination impedance is effective. In this case, as operation when a voltage exceeding the breakdown voltage of the internal device is applied, ½ of the termination resistance is added as the resistive element of the protection circuit, thereby providing similar advantages as a protection circuit. Taking a small signal equivalent circuit in differential signal input into consideration, the intermediate impedance node of the terminating device is equal to AC ground. Therefore, even when an element of any impedance is interposed between the intermediate impedance node and the ground potential of the terminating device, there is no influence on AC operation.

A common voltage is applied to the intermediate impedance node of the terminating device in transmission of a low amplitude signal. The common voltage is necessarily lower than the maximum value of the signal potential, and as the fluctuation range of the signal potential usually includes ½ of the fluctuation range of the signal amplitude in addition to the fluctuation range of the common potential. Therefore, the common potential has a smaller fluctuation range than the fluctuation range of the signal.

In addition to the advantage of reducing an influence on a terminating resistor, the present disclosure provides an excellent configuration, which maximizes the design margin of a protection circuit due to low signal potential and the small fluctuation range of the common potential.

As described above, in the present disclosure, for example, assume that a mobile memory card is inserted into a combination socket and comes into contact with a pull-up electrode terminal, which pulls up to a high voltage and is provided under other memory card standards. At this time, the resistive element connected in series to the diode element reduces the input voltage to be lower than the breakdown voltage. In normal use, the impedance of the protection circuit remains high to reduce the fluctuation in the impedance of the terminating device, thereby reducing the degradation in the signal quality. In particular, the input protection circuit according to the present disclosure is formed on a semiconductor integrated circuit, thereby providing a protection function at lower costs.

Furthermore, a protection circuit including a resistive element and a diode element, which are connected in series, is provided in an intermediate portion of a terminating device in a differential interface circuit, thereby providing a desired protection function and maintaining the signal quality.

### BRIEF DESCRIPTION OF THE DRAWINGS

FIG. 1 illustrates the configuration of an input protection circuit according to a first embodiment of the present disclosure.

FIG. 2 illustrates the specific configuration of a diode element included in the input protection circuit.

FIGS. 3A-3C illustrate an example configuration of a terminating device. FIG. 3A illustrates a pure resistor. FIG. 3B illustrates direct connection of a resistor and a capacitor. FIG. 3B illustrates direct connection of a resistor and an inductor.

FIG. 4 illustrates an absolute value |Γ| of a reflection coefficient with respect to absolute values of a ratio Zr and a phase difference θ_{d}, which means relationship between characteristic impedance Z0 of a transmission line and termination impedance Zₜₜ of a terminating device.

FIG. 5 illustrates the configuration of an input protection circuit for a differential interface circuit according to a variation of the embodiment.

FIG. 6 illustrates a specific configuration of a diode element included in the input protection circuit.

FIG. 7 illustrates the configuration of an input protection circuit according to a second embodiment of the present disclosure.

FIG. 8 illustrates the configuration of an input protection circuit according to a third embodiment of the present disclosure.

FIG. 9 illustrates a specific configuration of a diode element in the input protection circuit.

FIG. 10 illustrates a small signal equivalent circuit of a differential impedance circuit shown in FIG. 9.

FIGS. 11A-11C illustrate voltage ranges, in which the protection circuit is active, according to the first, second and third embodiments. FIG. 11A illustrates the first embodiment. FIG. 11B illustrates the second embodiment. FIG. 11C illustrates the third embodiment.

FIG. 12 illustrates the configuration of an input protection circuit according to a fourth embodiment of the present disclosure.

FIG. 13 illustrates a specific configuration of a diode element included in the input protection circuit.

FIG. 14A illustrates the configuration of a conventional clamping circuit. FIG. 14B illustrates the configuration of another conventional clamping circuit.

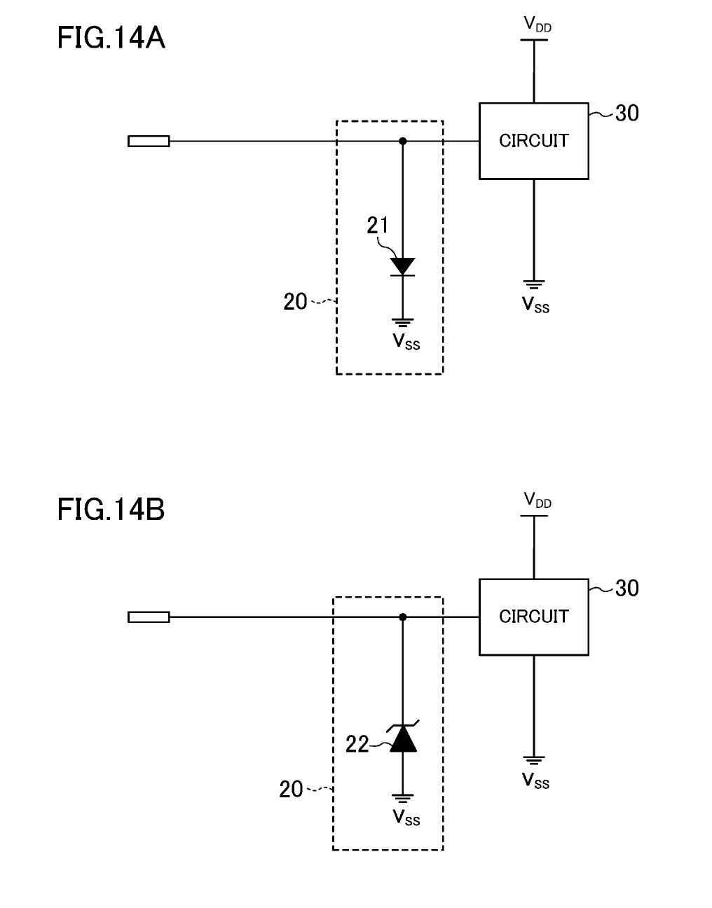

FIG. 15 illustrates the voltage-current characteristics of a diode element.

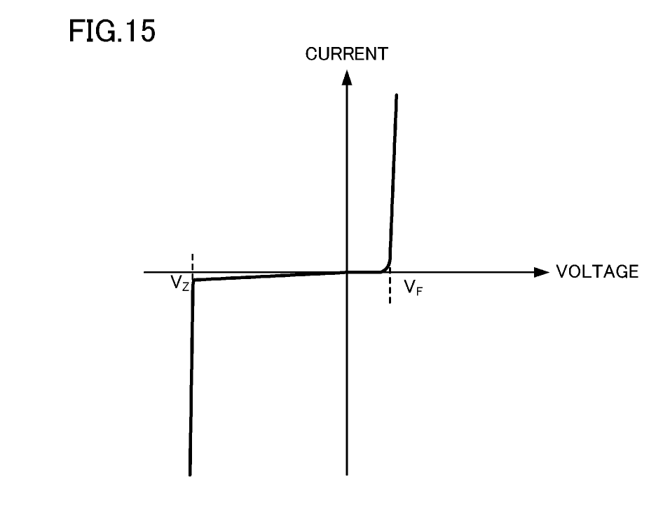

### DETAILED DESCRIPTION

Embodiments of the present disclosure will be described hereinafter with reference to the drawings.

### First Embodiment

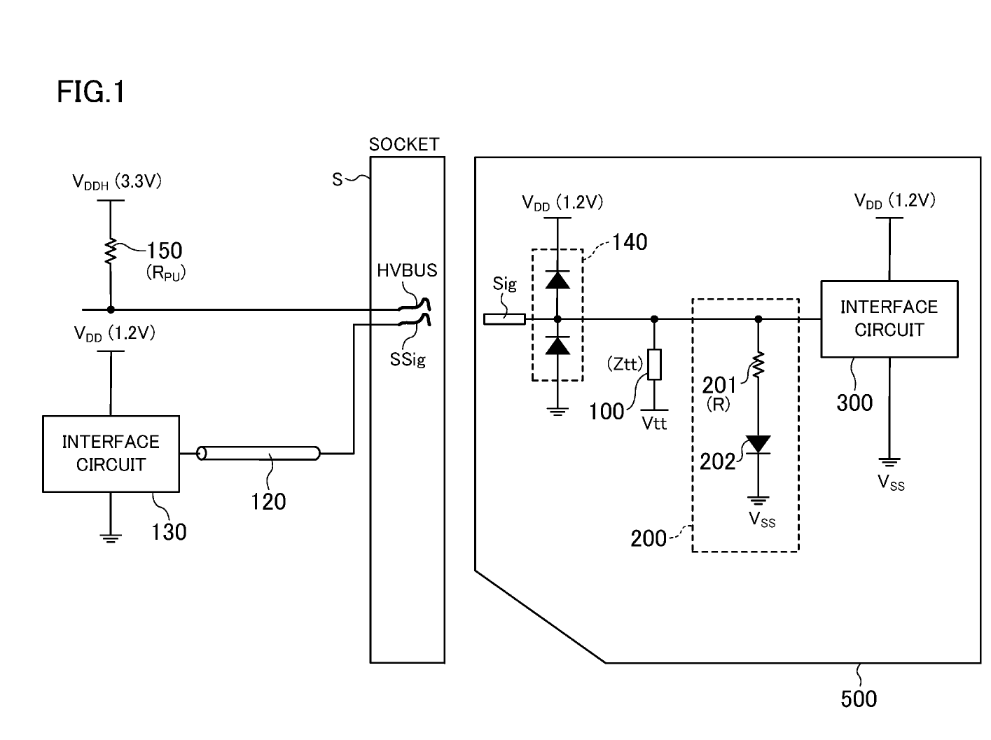

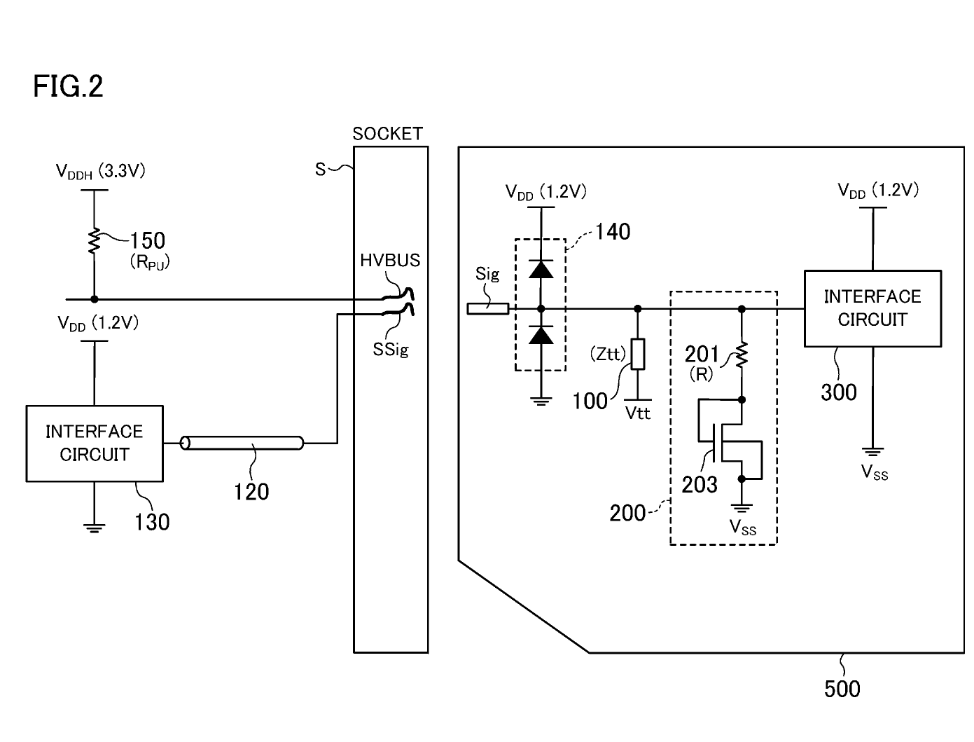

FIGS. 1 and 2 illustrate the configurations of an input protection circuit according to a first embodiment of the present disclosure.

In FIG. 1, reference numeral 500 denotes an insertable/extractable device such as a mobile memory card. An external terminal Sig included in the device 500 is a signal electrode, which is electrically connected to a terminal SSig of a socket S such as a combination socket when the device 500 is inserted into the socket S, and connected to an interface circuit 130 via the terminal SSig of the socket S and a communication path 120.

Inside the device 500, a terminating device 100 with predetermined impedance is interposed between a termination voltage supply Vₜₜ and a signal node (i.e., the external terminal Sig). A protection circuit 200 including a resistive element 201 and a diode element 202, which are connected in series, is provided in parallel to the terminating device 100.

The external terminal Sig is connected to an interface circuit 300, which receives and sends signals via the external terminal Sig. This interface circuit 300 may be an input circuit, an output circuit, or an input/output circuit. The interface circuit 300 is to be protected from an external high voltage V_{DDH} when erroneously coming into contact with a signal terminal HVBUS in the socket S, which is pulled up to the high voltage V_{DDH}, via a resistor 150. An ESD protection circuit 140 is connected to the external terminal Sig.

FIG. 2 illustrates a MOS transistor 203 as a specific example of the diode element 202 in FIG. 1 to utilize the diode characteristics of the MOS transistor 203. This embodiment is suitable for mounting the input protection circuit on a semiconductor integrated device. While the MOS transistor 203 is an n-type MOS transistor in FIG. 2, it may be a p-type MOS transistor, which provides similar advantages as a diode.

The protection circuit 200 according to this embodiment is characterized by how to determine the resistance of the resistive element 201. First, it is necessary to determine a parameter to exhibit a voltage protection function as a primary function of the present disclosure, when the external terminal Sig is in contact with the signal terminal HVBUS, which is pulled up to the high voltage V_{DDH} via the resistor 150. This primary function will be described below.

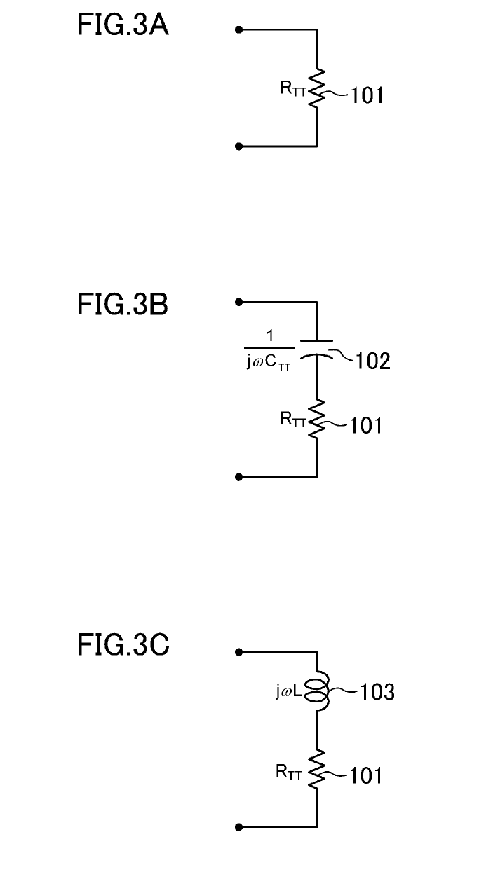

First, assume that termination impedance obtained in a predetermined frequency required by the terminating device 100 for matching is a real number, i.e., resistance. FIGS. 3A and 3B illustrate example configurations of a terminating device where the termination impedance is a real number. FIG. 3C illustrates an example configuration of a terminating device where the termination impedance is a complex value. FIG. 3A illustrates a terminating device including a pure resistor 101, and terminates all frequency ranges at a constant value. FIG. 3B illustrates a terminating device including the resistor 101 and a capacitor 102, which are connected in series. In FIG. 3B, a capacitive component is dominant in the termination impedance at a low frequency. Since the impedance of the capacitor 102 is negligible as compared to the impedance of the resistor 101 at a given frequency or more, desired termination impedance can be obtained as resistance. FIG. 3C illustrates a terminating device including a resistor 101 and an inductor 103, which are connected in series.

An example will be described where a system matches a 50Ω transmission line, which is generally often used. Assume that the protection circuit 200 is formed on a semiconductor integrated circuit, and utilizes a MOS transistor as a diode element. The power supply voltage V_{DD} of the interface circuit 300 is normally 1.2 V and 1.1 V at minimum, the desired termination impedance is 50Ω, and the power supply voltage V_{DDH} of the signal electrode terminal HVBUS of the socket S is normally 3.3 V and 3.6 V at maximum. The power supply voltage V_{DDH} may be pulled up via a resistor 150 with resistance R_{PU} ranging from 10 kΩ to 100 kΩ. In this case, an example where the protection circuit 200 pulls down the voltage of the external terminal Sig to 1.2 V or less will be described below using specific numerical values.

The termination voltage Vₜₜ may be equal to ground in a small signal equivalent circuit using AC signals. A specific voltage value is determined by the electrical specification of the interface circuit 300.

In the worst case, in view of the variations, the threshold of the MOS transistor 203 is the maximum, the power supply voltage V_{DD} of the interface circuit 300 is the minimum, the power supply voltage V_{DDH} of the signal electrode terminal HVBUS is the maximum, and the resistance R_{PU} of the pull-up resistor 150 is the minimum value 10 kΩ. Assume that the threshold of the MOS transistor 203 is the maximum value of 500 mV, the power supply voltage V_{DD} of the interface circuit 300 is the minimum value of 1.1 V, and the power supply voltage V_{DDH} of the signal electrode terminal HVBUS is the maximum value of 3.6 V. The resistance R of the resistive element 201 is determined as follows that when the diode element 202 (the MOS transistor 203) is on, the voltage value obtained from dividing the remaining voltage (3.6−0.5) V=3.1 V by the division ratio R/(10 kΩ+R), which is the ratio of the resistance R of the resistive element 201 to the combined resistance of the resistance R of the resistive element 201 and the resistance R_{PU} (i.e., 10 kΩ) of the pull-up resistor 150 at the socket S, is pulled down to (1.1−0.5) V=0.6 V or less. That is, the resistance R of the resistive element 201 is

$$\frac{10 k \times 0.6}{( 3.1 - 0.6 )} = 2.4 k Ω \qquad ( 1 )$$

or less.

Next, in normal use, an influence of the protection circuit 200 on the termination impedance is considered. The impedance of the protection circuit 200 according to the present disclosure is the sum of the resistance R of the resistor 201 and the impedance of the diode element 202. However, the protection circuit 200 is connected in parallel to the terminating resistor 100. Thus, when the impedance of the protection circuit 200 is the minimum, the worst condition occurs in which the fluctuations influence on termination impedance characteristics at maximum. In this case, while the resistance R of the resistive element 201 is a fixed value, the impedance of the diode element 202 is the parallel impedance of the parasitic capacitance and the on-resistance. In view of the fact that the impedance of the parasitic capacitance becomes asymptotically equal to −j0 in a high-frequency region and negligible as compared to the resistance R of the resistive element 201, the worst condition is where the impedance of the protection circuit 200 is equal to the resistance R of the resistive element 201.

At this time, for example, when the fluctuation amount of the termination impedance of the terminating resistor 100 is to be about 5%, the resistance R of the resistive element 201 needs to meet, from

$${[ \frac{1}{50} + \frac{1}{R 1} ]}^{- 1} \geq 45 \qquad ( 2 )$$

the requirement

R1≧450Ω (3)

Therefore, in actual mounting of this embodiment, the resistance R of the resistive element 201 included in the protection circuit 200 may be determined in the range from 450Ω to 2.4 kΩ in accordance with margins of input protection voltage and a tolerant fluctuation range of the terminating resistor characteristics, or design factors such as mounting areas and cost factors.

In a transmission line such as an RC line, in which a loss component is dominant, the characteristic impedance is represented by a complex number, the condition for matching of the termination impedance of the terminating device 100 needs to be represented by en equivalent complex number to that of the transmission line. For example, the characteristic impedance Z0 of the transmission line is expressed by the following equation.

Z0=|Z0|e^{jθ}^{₀} (4)

In this equation, j represents an imaginary unit, θ₀ represents the phase of Z0 in a complex impedance plane, |Z0|cos θ₀ represents the real component of the impedance Z0, and j|Z0|sin θ₀ represents the imaginary component. The termination impedance Zₜₜ of the terminating device 100 is expressed by the following equation.

Ztt=|Ztt|e^{jθ}^{ₜₜ} (5)

θₜₜ represents the phase of the complex termination impedance Zₜₜ of the terminating device 100 in the impedance plane, |Zₜₜ|cos θₜₜ represents the real component of the impedance Zₜₜ, and j|Zₜₜ|sin θₜₜ represents the imaginary component. The reflectivity coefficient Γ of the terminating device 100 in the circuit in which the transmission line is connected to the terminating device 100 is expressed by the following equation.

$$Γ = \frac{Ztt - Z 0}{Ztt + Z 0} \qquad ( 6 )$$

The absolute value |Γ| is expressed by the following equation.

$$\vert Γ \vert = \sqrt{\frac{{\vert Ztt \vert}^{2} + {\vert Z 0 \vert}^{2} - 2 \vert Ztt \vert \vert Z 0 \vert cos ( {θ}_{tt} - {θ}_{0} )}{{\vert Ztt \vert}^{2} + {\vert Z 0 \vert}^{2} + 2 \vert Ztt \vert \vert Z 0 \vert cos ( {θ}_{tt} - {θ}_{0} )}} \qquad ( 7 )$$

Where Zₜₜ is Z0, the reflectivity coefficient Γ is 0, which indicates the matching. Even if the absolute values are equal as expressed by |Zₜₜ|=|Z0|, the reflectivity coefficient Γ is not 0, as long as the phases are not equal (i.e., θₜₜ≠θ₀), thereby causing some reflected waves. That is, when the termination impedance Zₜₜ of the terminating device 100 is complex impedance, both of the fluctuation amount of the absolute value |Zₜₜ| and the fluctuation amount of the phase θₜₜ are factors influencing the signal quality.

With respect to the characteristic impedance of the transmission line and he termination impedance of the terminating device 100, where the ratio of the absolute value |Zₜₜ| of the termination impedance to the transmission line impedance |Z0| is Zr, and the difference between the phase θₜₜ of the complex termination impedance and the phase θ₀ of the complex characteristic impedance Z0 is θ_{d}, the absolute value |Γ| of the reflectivity coefficient is calculated as the ratio of the absolute value and the difference between the phases, as expressed by the following equations.

$$\vert Γ \vert = \sqrt{\frac{{Zr}^{2} + 1 - 2 Zr cos {θ}_{d}}{{Zr}^{2} + 1 + 2 Zr cos {θ}_{d}}} \\ [ Zr = \frac{\vert Ztt \vert}{\vert Z 0 \vert} , {θ}_{d} = {θ}_{tt} - {θ}_{0} ] \qquad ( 8 )$$

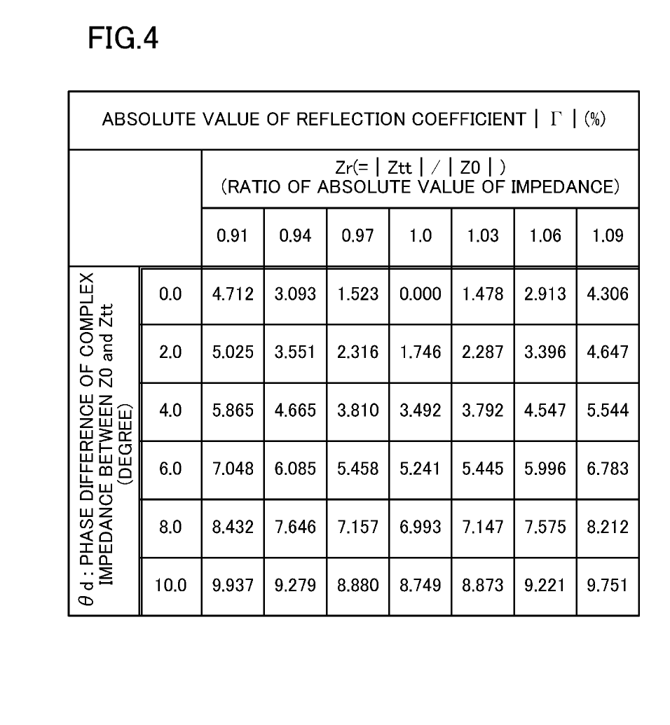

FIG. 4 illustrates the absolute value |Γ| of the reflectivity coefficient calculated by the relationship between the phase difference θ_{d} between the phases and the ratio Zr (i.e., |Zₜₜ|/|Z0|) of the absolute value of the complex characteristic impedance Z0 of the transmission line to the absolute value of the complex termination impedance Zₜₜ of the terminating device using the equations (8). In this table, the step size of the ratio Zr is 3%, and the step size of the phase difference θ_{d} between the phases is 2 degree. The equations Zr=1.00 and θd=0 are the conditions for impedance matching, i.e., the reflectivity coefficient 0. As seen from the table, the fluctuation amount of the reflectivity coefficient falls within about 2.5% even when a fluctuation in the ratio Zr of the absolute value by 3% and a fluctuation in the phase difference θ_{d} between the phases by 2 degree from the match condition simultaneously occur.

Using this protection circuit 200 as an ESD protection circuit is not realistic, since the impedance is too high, and currents flow in one direction. There is a need to provide an ESD protection circuit 140 extra, which inherently differs from the present disclosure. Therefore, the protection circuit 200 does not serve as an ESD protection circuit. If the ESD protection diode element provided extra is used as a measure for achieving the objective, a forward direction current continuously flows to the protection diode at the power supply side and a driver circuit etc., of the interface circuit, thereby accelerating the deterioration in the device characteristics. In such a circuit, the external terminal has the voltage obtained by adding the threshold voltage of the ESD protection diode to the power supply voltage. The PMOS transistors forming the interface circuit and connected to external terminals at the gate terminals, meet the PBTI degradation conditions, which may accelerate characteristic fluctuations. Therefore, such mounting is preferably to be avoided in view of the reliability.

### Variation

The protection circuit 200 provides similar advantages when connected to differential signal terminals of a differential interface.

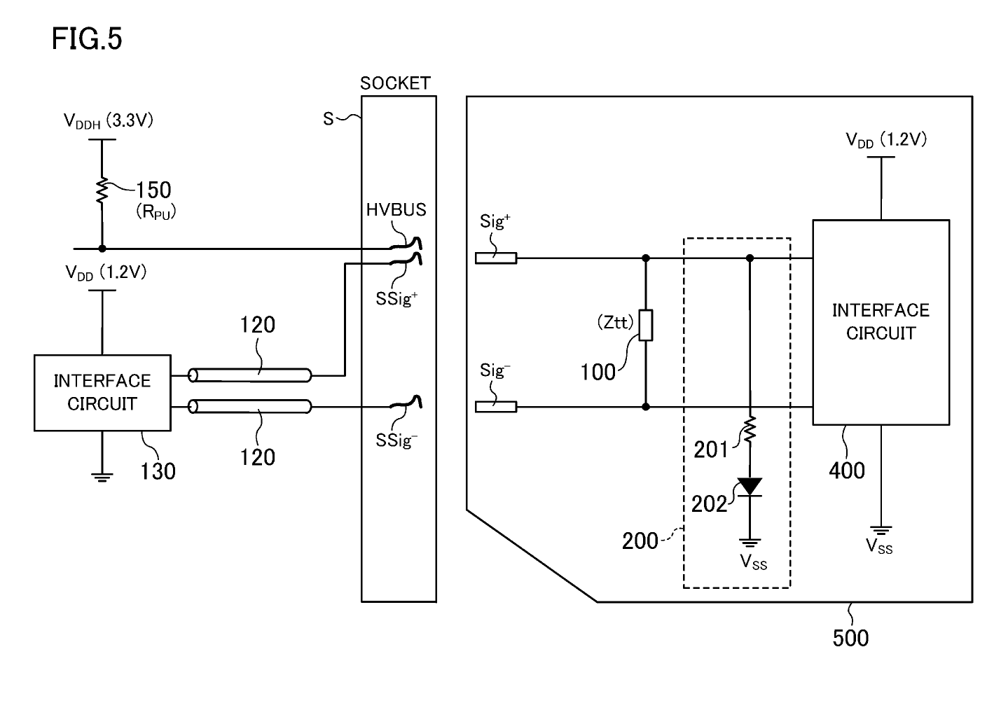

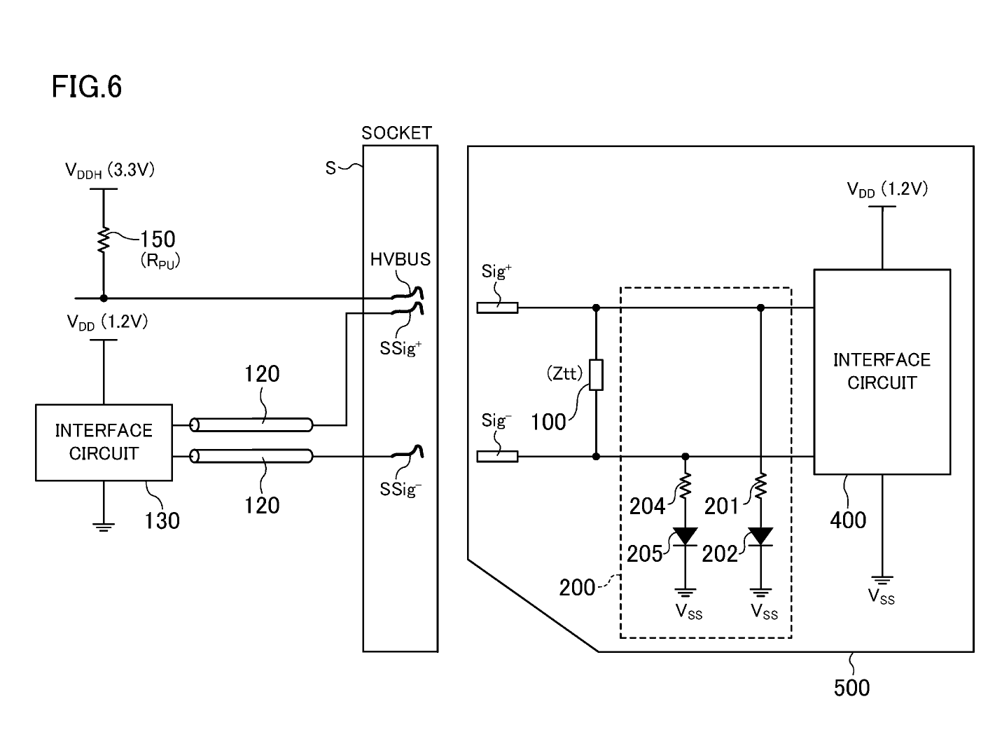

FIGS. 5 and 6 illustrate the configurations of a variation of the first embodiment where a protection circuit is applied to a differential interface circuit.

In the figures, a terminating resistor 100 with resistance of, for example, 20-400Ω is connected between a pair of differential signal terminals Sig⁺ and Sig⁻ of a differential interface circuit 400. The terminal Sig⁺, which is one of the pair of differential signal terminals, is connected in series to a resistive element 201 and a diode element 202. The other terminal Sig⁻ is connected to a resistive element 204 and a diode element 205 in series. As a result, the protection circuit 200 is formed.

The power supply voltage V_{DDH} of a signal electrode terminal HVBUS of a socket S is normally 3.3 V, and 3.6 V at maximum. As long as the power supply voltage V_{DDH} may be pulled up via the pull-up resistor 150 of 5-500 kΩ, similar advantages are provided even if only one of the pair of differential signal terminals Sig⁺ and Sig⁻ is connected the protection circuit 200. Clearly, similar advantages are provided if both of the pair of differential signal terminals Sig⁺ and Sig⁻ are connected.

In FIGS. 5 and 6, a single signal terminal HVBUS pulled up to the high voltage V_{DDH} via the resistor 100 in the socket S is provided close to a signal terminal SSig⁺. Similarly, it is clear that a signal terminal HVBUS (not shown) pulled up to the high voltage V_{DDH} via another resistor may be provided close to the signal terminal Sig⁻.

In the embodiment shown in FIGS. 1, 2, 5 and 6, the protection circuits 200 perform protection in response to the high voltage V_{DDH} applied to the external terminal Sig (or Sig⁺ and Sig⁻), and does not depend on the operational state of the interface circuit 300 or 400. Thus, as an additional advantage, the protection circuits 200 are suitable for a device, in which hot plug is frequently performed and a high voltage V_{DDH} is applied to the external terminal Sig (or the external terminals Sig⁺ and Sig⁻) before the internal state is determined as in the case where the interface circuits 300 and 400 are mobile memory cards.

Clearly in this embodiment, where the diode element 202 is a diode element formed by PN junction only, the connection of the resistive element 201 and the diode element 202 may be replaced with each other, thereby providing similar advantages. Where the diode element 202 is a MOS transistor, the resistive element 201 and the diode element 202 may be replaced with each other, thereby providing similar advantages as the protection circuit 200. In this case, however, since the drain-substrate junction capacitance of the MOS transistor is added to input capacitance, there is a need to consider that the influence on the termination impedance characteristics changes.

### Second Embodiment

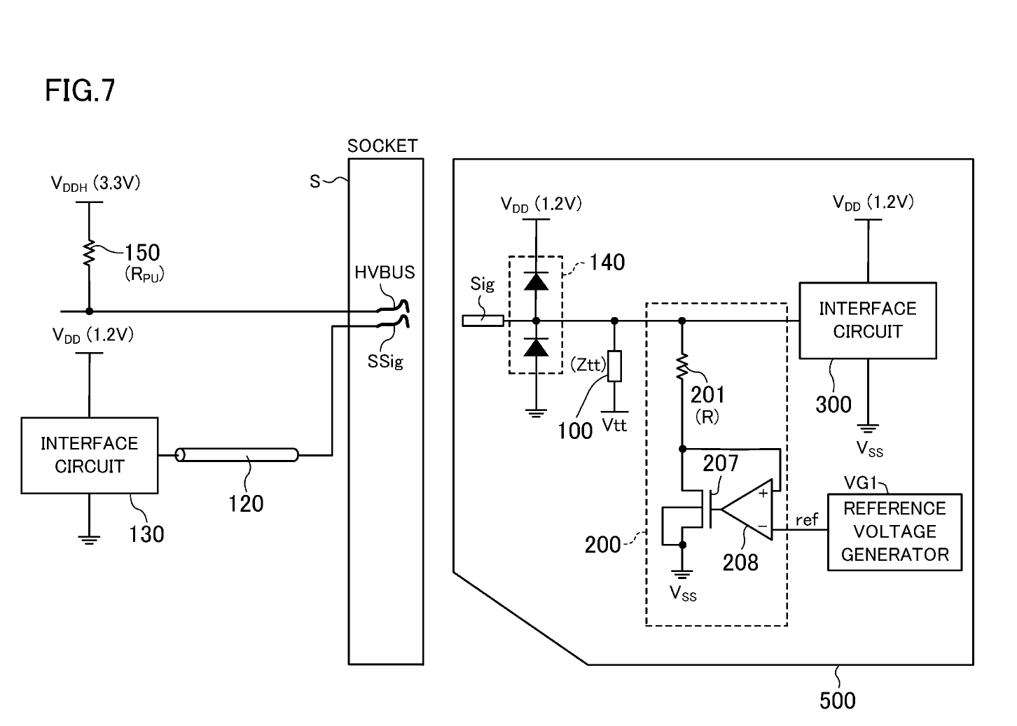

FIG. 7 illustrates the configuration of an input protection circuit according to a second embodiment of the present disclosure.

In the protection circuit 200 shown in FIG. 2 of the first embodiment, the MOS transistor diode element 203 is replaced with a source voltage follower circuit including an NMOS transistor 207 and a differential amplifier 208 in FIG. 7. In this source voltage follower circuit, a gate terminal of the NMOS transistor 207 is connected to an output of the differential amplifier 208. A non-inverting input of the differential amplifier 208 is connected to a drain terminal of the NMOS transistor 207. A reference voltage ref, which is generated by a reference voltage generator VG1, is input to an inverting input of the differential amplifier 208.

As operation, the source voltage follower circuit pulls down the voltage of the output terminal connected to the gate terminal, while the drain termination voltage of the NMOS transistor 207 is lower than the reference voltage ref. Thus, the NMOS transistor 207 remains off. When the drain termination voltage of the NMOS transistor 207 becomes higher than or equal to the reference voltage ref, the differential amplifier 208 pulls up the gate voltage of the NMOS transistor 207. When the NMOS transistor 207 is on, the differential amplifier 208 operates to pull down the drain termination voltage so that the drain voltage of the NMOS transistor 207 is stable around the reference voltage ref.

In this embodiment, the differential amplifier 208 and the reference voltage generator VG1 accurately determine the threshold voltage of the NMOS transistor 207, and are thus designed without taking variations in the threshold voltage into consideration. The resistance R of the resistive element 201 included in the protection circuit 200 is determined by a means similar to that of the first embodiment by replacing the threshold of the diode element with the reference voltage ref. The fluctuation amount of reflectivity coefficient Γ where the termination impedance of the terminating device 100 is a complex number is calculated similarly to the first embodiment.

### Third Embodiment

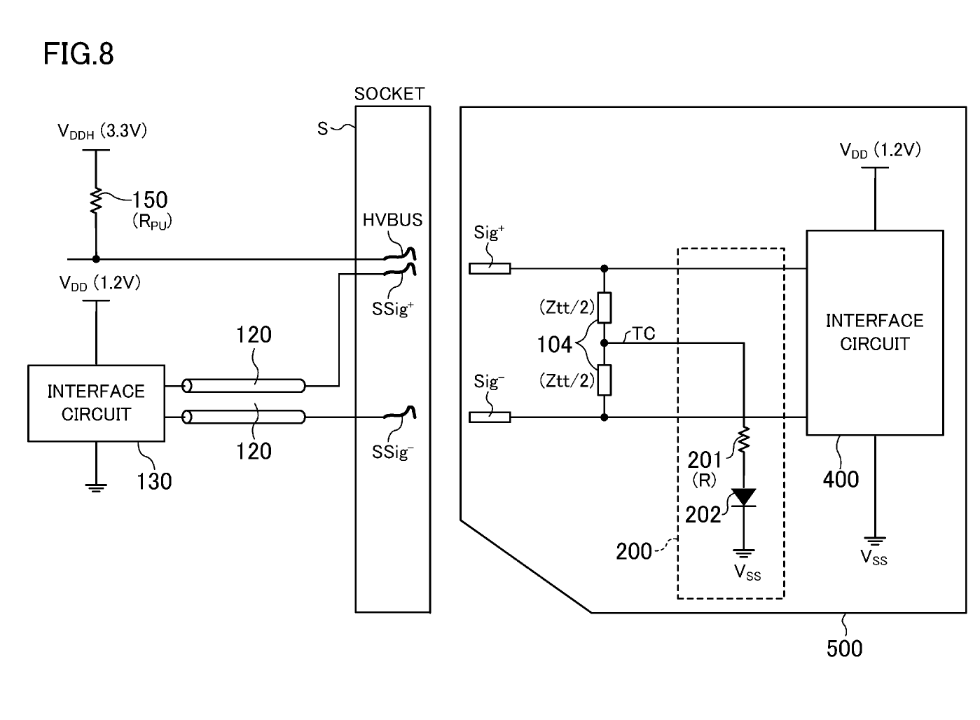

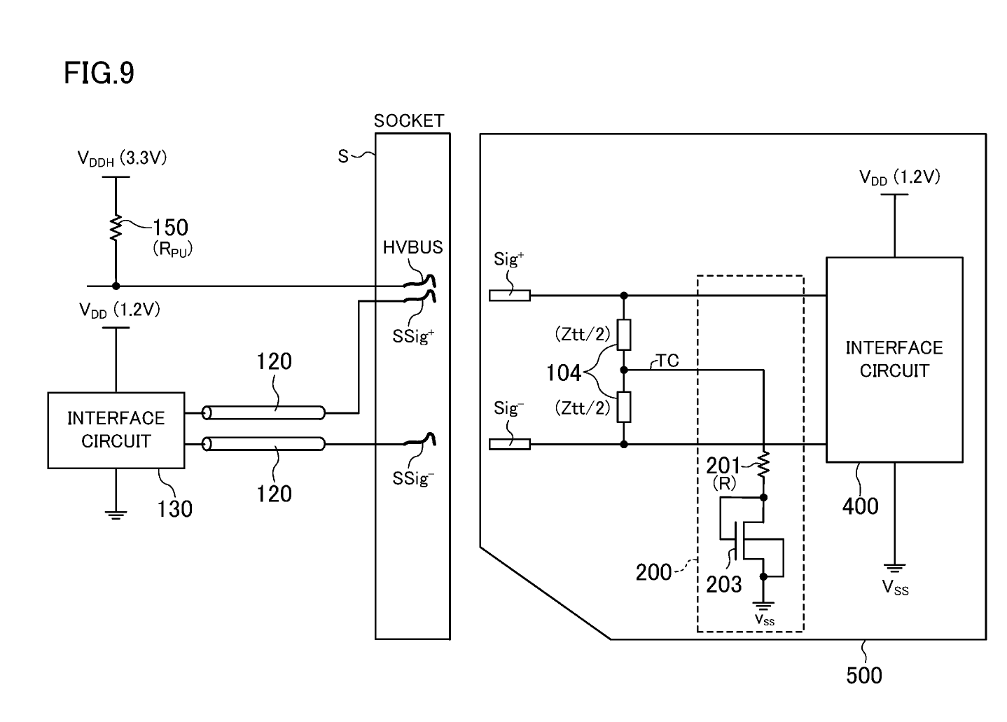

FIGS. 8 and 9 illustrate the configurations of an input protection circuit according to a third embodiment of the present disclosure.

In FIG. 8, reference numeral 500 denotes an insertable and extractable device such as a mobile memory card including a differential interface, in which a terminating device 104 is connected between a pair of differential signal terminals Sig⁺ and Sig⁻. The differential signal terminals Sig⁺ and Sig⁻ included in the device 500 are external terminal electrodes electrically connected to differential signal electrodes SSig⁺ and SSig⁻ included in a socket S.

Inside the device 500, the terminating device 104 having predetermined impedance is interposed between the pair of differential signal terminals Sig⁺ and Sig⁻. An intermediate node TC, in which the impedance of the terminating device 100 is half, is connected to a protection circuit 200 including a resistive element 201 and a diode element 202, which are connected in series. The diode element 202 has an anode connected to the resistive element 201, and a cathode connected to a reference potential. The pair of differential signal terminals Sig⁺ and Sig⁻ are connected to a differential interface circuit 400 to be protected from an external voltage. The differential interface circuit 400 is an input circuit, an output circuit, or an input/output circuit.

FIG. 9 illustrates a MOS transistor diode element 203 as a specific example of the diode element 202 in FIG. 8. In the MOS transistor diode element 203, a drain terminal is connected to a gate terminal to form an anode terminal, and a source terminal is a cathode terminal, thereby utilizing the diode characteristics.

In this embodiment, the resistance R of the resistive element 201 of the protection circuit 200 may be determined to provide a voltage protection function, when the signal terminal Sig⁺ is in contact with a signal terminal HVBUS of the socket S, which is pulled up to a high voltage V_{DDH} via a high-resistance resistor 150. The resistance R is determined similarly to the first embodiment using the division ratio {R+(Rₜₜ/2)}/{R_{PU}+(R+Rₜₜ/2)} in view of the fact that the DC impedance of a terminating device Zₜₜ, i.e., ½ of the real component Rₜₜ (i.e., Rₜₜ/2) is added to the resistance R of the resistive element 201 of the protection circuit 200.

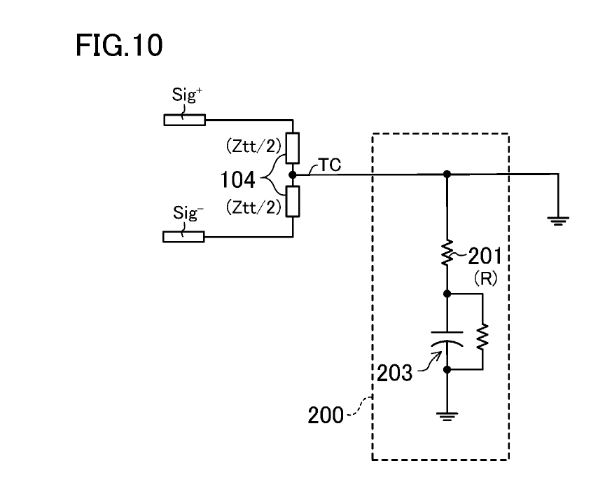

In the differential interface circuit according to this embodiment, the intermediate impedance node TC of the terminating device 104 corresponds to a common voltage point. That is, as shown in FIG. 10, in a small signal equivalent circuit where differential signals are input to the pair of differential signal terminals Sig⁺ and Sig⁻, the intermediate impedance node TC is a ground node. Thus, even if a circuit having any impedance is interposed between the intermediate node TC and the ground potential, the combined impedance of the AC signal component is 0 not to influence the waveform quality of signals.

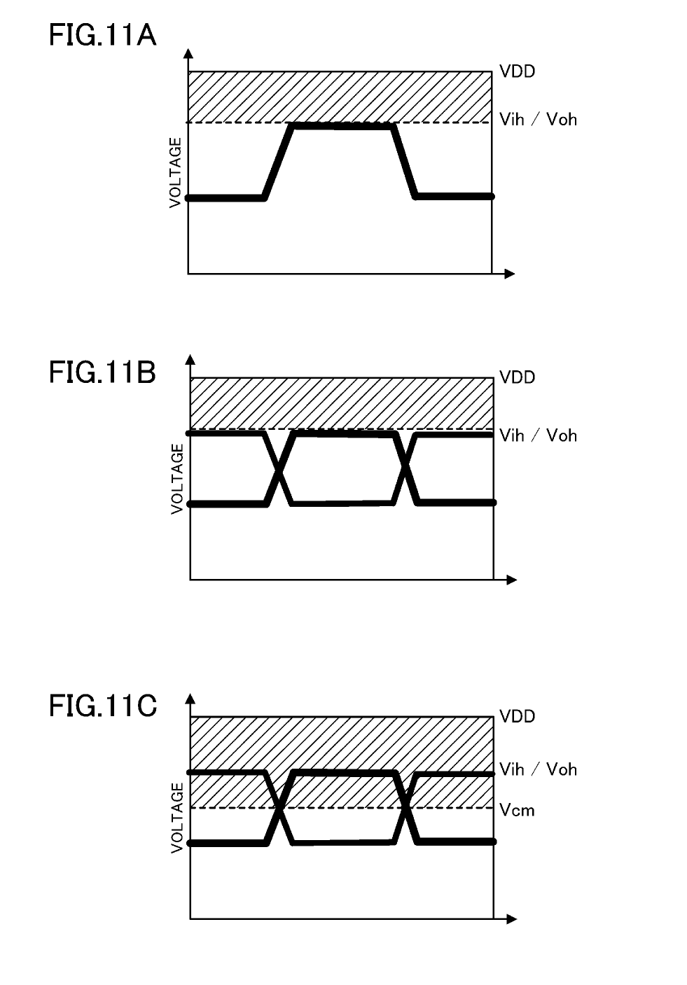

A common voltage is applied as DC to the intermediate impedance node TC during transmission/reception of a low amplitude signal. As shown in FIG. 11C, a common voltage Vcm is necessarily lower than a high potential level Vih of an input signal, or a high potential level Voh of an output signal. In general, the fluctuation range of the common potential Vcm is relatively smaller than the fluctuation range of a signal potential, since ½ of the fluctuation range of signal amplitude is added to the fluctuation range of the common potential Vcm. In the first and second embodiments shown in FIGS. 11A and 11B, the protection circuit 200 performs on-operation in a voltage range over a high potential level Vih of an input signal or a high potential level Voh of an output signal. In this embodiment, as shown in FIG. 11C, due to the low level and the small fluctuation range of the common potential Vcm as compared to the signal potential, the on-region of the diode element 202 of the protection circuit 200 falls within the voltage range over the common potential Vcm so that the protection circuit 200 is unlikely to enter the operation region in transmission of differential signals. This maximizes the design margin.

In this embodiment, the protection circuit 200 performs protection operation in response to the high voltage applied to the external terminals Sig⁺ and Sig⁻, and does not depend on the operational state of the interface circuit 400. Thus, as an advantage, the protection circuit 200 is suitable for a device, in which hot plug is frequently performed and a high voltage is applied to the external terminals before the internal state is determined as in the case where the interface circuit 400 is a mobile memory card.

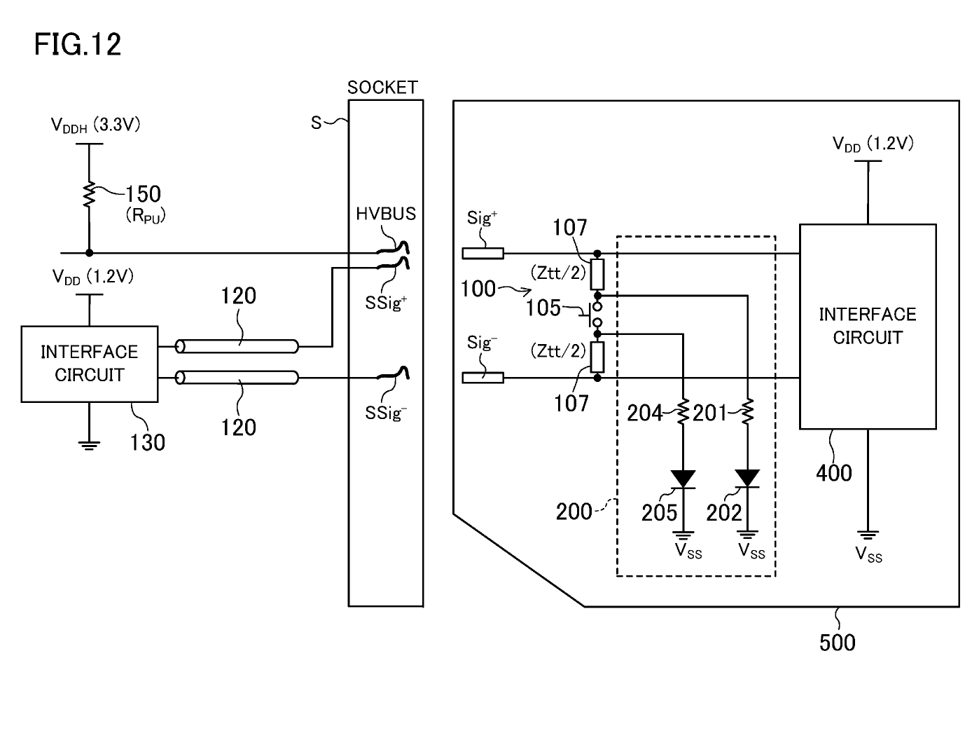

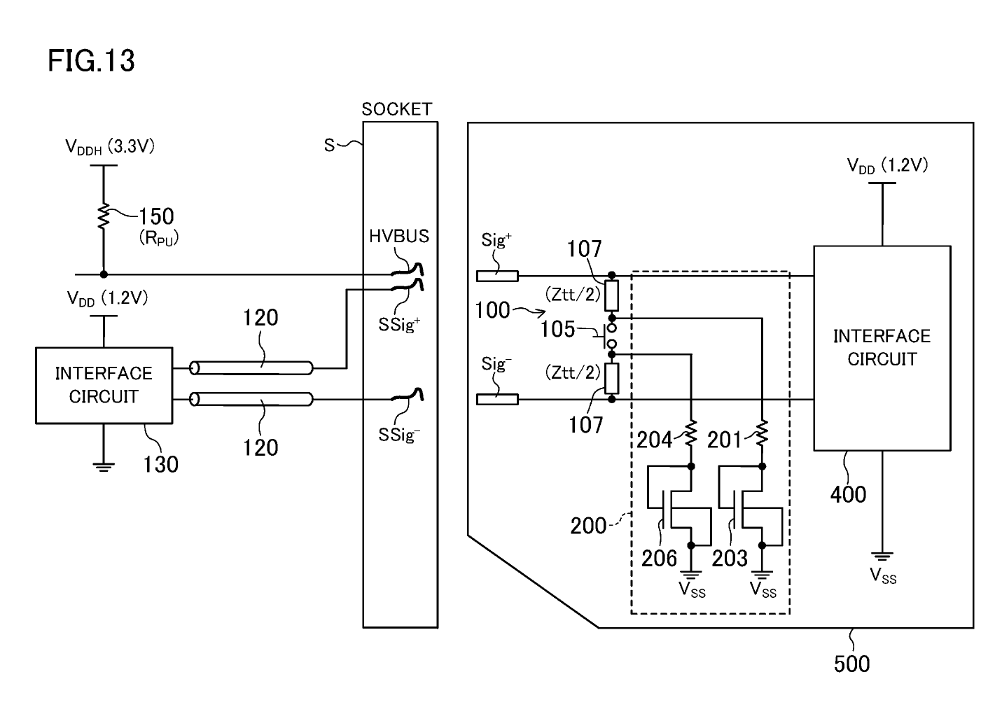

FIGS. 12 and 13 illustrate input protection circuits according to a fourth embodiment of the present disclosure.

In FIG. 12, reference numeral 500 is an insertable and extractable device such as a mobile memory card including a terminating device 100 between a pair of differential signal terminals Sig⁺ and Sig⁻. The terminating device 100 includes two terminating circuits 107 connected in series, each of which serves for ½ termination impedance. An intermediate impedance point of the terminating device 100 is connected to a connecting switch 105 for switching connection/disconnection of the terminating device 100 to the differential signal terminals Sig⁺ and Sig⁻. The device 500 also includes a differential interface circuit 400.

The ON/OFF state of the connecting switch 105 is controlled in accordance with the unidirectional/bidirectional communication mode, etc., of the device 500. The pair of differential signal terminals Sig+ and Sig− of the device 500 is electrically connected to a pair of differential signal terminals SSig+ and SSig− of a socket S.

One end of the connecting switch 105 is connected in series to a resistive element 201 and a diode element 202. The other end of the connecting switch 105 is connected in series to another resistive element 204 and another diode element 205. As a result, the protection circuit 200 is formed.

FIG. 13 illustrates MOS transistor diode elements 203 and 206 as a specific example of the diode elements 202 and 205. In each of the MOS transistor diode elements 203 and 206, a drain terminal is connected to a gate terminal to form an anode terminal, and a source terminal is a cathode terminal, thereby utilizing the diode characteristics. While the diode elements are n-type MOS transistors in FIG. 13, they may be p-type MOS transistors, which provide similar advantages as diode elements.

With this configuration, similar to the third embodiment, the influence of the impedance of the protection circuit 200 is greatly reduced in view of the small signal equivalent circuit of the terminating device 100 and the protection circuit 200 in this embodiment.

In this embodiment, the protection circuit 200 performs protection operation in response to a high voltage applied to the external terminals Sig⁺ and Sig⁻, and does not depend on the ON/OFF state of the connecting switch 105, which is the operational state of the interface circuit 400. Thus, as an advantage, the protection circuit 200 is suitable for a device, in which hot plug is frequently performed and a high voltage is applied to the external terminals before the internal state is determined as in the case where the interface circuit 400 is a mobile memory card.

As described above, the protection circuit according to the present disclosure can be designed using digital transistors. The protection circuit has a circuit configuration requiring a small area in a semiconductor integrated circuit without additional external parts, and provides data transmission ensuring termination impedance. Therefore, the protection circuit is useful for, for example, an interface circuit for a mobile memory card, which is frequently inserted into a combination socket of a personal computer.

What is claimed is:

1. An input protection circuit equipped with an external terminal, and configured to limit a voltage applied to a low-amplitude interface circuit connected to the external terminal when the external terminal is connected via a resistor to a voltage supply having a voltage exceeding an acceptable applied voltage, the input protection circuit comprising:
a terminating device connected to the external terminal; and
a protection circuit connected in parallel to the terminating device, wherein
the protection circuit includes
a resistive element having an end connected to the external terminal, and
a diode element having an anode terminal connected to another end of the resistive element, and a cathode terminal connected to a reference potential terminal.

2. The input protection circuit of claim 1, wherein
termination impedance obtained within a frequency range required by the terminating device for matching is represented by a real number, and
resistance of the resistive element of the protection circuit is determined such that an absolute value of parallel combined impedance of impedance of the resistive element and the termination impedance falls within a predetermined fluctuation range from an absolute value of the termination impedance.

3. The input protection circuit of claim 2, wherein
the predetermined fluctuation range is within 5% of the absolute value of the termination impedance.

4. The input protection circuit of claim 1, wherein
resistance of the resistive element of the protection circuit is determined such that an absolute value of parallel combined impedance of impedance of the resistive element and termination impedance, which is obtained within a frequency range required by the terminating device for matching, falls within a fluctuation range of 3% from an absolute value of the termination impedance, and such that a phase difference between a phase of the parallel combined complex impedance and a phase of the complex termination impedance falls within 2 degrees.

5. The input protection circuit of claim 1, wherein
the diode element is a MOS transistor element on a semiconductor integrated circuit.

6. The input protection circuit of claim 1, wherein
the low-amplitude interface circuit is a differential interface circuit,
both ends of the terminating device are connected to a pair of differential signal terminals of the differential interface circuit, and
a series-connected circuit of the resistive element and the diode element is connected to one or both of the pair of differential signal terminals.

7. An input protection circuit equipped with an external terminal, and configured to limit a voltage applied to a low-amplitude interface circuit connected to the external terminal when the external terminal is connected via a resistor to a voltage supply having a voltage exceeding an acceptable applied voltage, the input protection circuit comprising:
a terminating device connected to the external terminal; and
a protection circuit connected in parallel to the terminating device, wherein
the protection circuit includes
a resistive element having an end connected to the external terminal,
an n-type MOS transistor having a drain terminal connected to another end of the resistive element, and a source terminal connected to a reference potential terminal, and
a differential amplifier having an output terminal connected to a gate terminal of the n-type MOS transistor, a non-inverting input terminal of the differential amplifier being connected to the drain terminal of the n-type MOS transistor, and an inverting input terminal of the differential amplifier receiving a reference voltage generated by a reference voltage generator.

8. The input protection circuit of claim 7, wherein
termination impedance obtained within a frequency range required by the terminating device for matching is represented by a real number, and
resistance of the resistive element of the protection circuit is determined such that an absolute value of parallel combined impedance of impedance of the resistive element and the termination impedance falls within a predetermined fluctuation range from an absolute value of the termination impedance.

9. The input protection circuit of claim 8, wherein
the predetermined fluctuation range is within 5% of the absolute value of the termination impedance.

10. The input protection circuit of claim 7, wherein
resistance of the resistive element of the protection circuit is determined such that an absolute value of parallel combined impedance of impedance of the resistive element and termination impedance, which is obtained within a frequency range required by the terminating device for matching, falls within a fluctuation range of 3% from an absolute value of the termination impedance, and such that a phase difference between a phase of the parallel combined complex impedance and a phase of the complex termination impedance falls within 2 degrees.

11. An input protection circuit equipped with a pair of external terminals, and configured to limit a voltage applied to a low-amplitude interface circuit connected to one or both of the pair of external terminals when the one or both of the pair of external terminals is/are connected via a resistor to a voltage supply having a voltage exceeding an acceptable applied voltage, the input protection circuit comprising:
a terminating device connected between the pair of external terminals; and
a protection circuit connected in parallel to the terminating device, wherein
the protection circuit includes
a resistive element having an end connected to an intermediate impedance point of the terminating device, and
a diode element having an anode terminal connected to another end of the resistive element, and a cathode terminal connected to a ground terminal.

12. The input protection circuit of claim 11, further comprising:
at the intermediate impedance point of the terminating device, a switch switchable between electrical connection and disconnection between the pair of external terminals via the terminating device, wherein
a series-connected circuit of the resistive element and the diode element is connected to each terminal of the switch.

13. The input protection circuit of claim 11, wherein
the diode element is a MOS transistor element on a semiconductor integrated circuit.
